(19) United States
(12) Patent Application Publication
(10) Pub. No.: US 2025/0012331 A1
(43) Pub. Date: Jan. 9, 2025

(54) BRAKING DEVICE

(71) Applicant: Edscha Engineering GmbH, Remscheid (DE)

(72) Inventors: Jose-Manuel Gutierrez-Fernandez, Sobremazas (ES); Jochen BALS, Remscheid (DE); Matthias Obrig, Remscheid (DE)

(21) Appl. No.: 18/712,689

(22) PCT Filed: Dec. 1, 2022
(86) PCT No.: PCT/DE2022/100902

§ 371 Date: May 22, 2024

(30) Foreign Application Priority Data
Dec. 1, 2022 (DE) 20 2021 106 598.2

(51) Int. Cl. F16D 49/16; E05F 5/00; E05F 15/603; F16D 7/02; F16D 59/00; F16D 63/00; F16D 121/14; F16D 121/18; F16D 121/20; F16D 121/22; F16D 121/24; F16D 121/26; F16D 125/40; F16D 127/00

(52) U.S. Cl. CPC F16D 49/16; F16D 7/021; F16D 59/00; F16D 63/00; E05F 5/00; E05F 15/603; E05Y 2201/21; E05Y 2201/246; E05Y 2201/266; F16D 2121/14; F16D 2121/18; F16D 2121/20; F16D 2121/22; F16D 2121/24; F16D 2121/26; F16D 2125/40; F16D 2127/00

(57) ABSTRACT

A braking device for a driveable part includes a driveable loading device which can be brought into radial contact with the driveable part having a first holding position and a second releasing position. At least one breaking member of the holding position bears frictionally against a radial circumference of the driveable part and secures the driveable part against rotation with a pre-settable force. The releasing position of the braking member permits a freewheeling of the driveable part. The loading device is adjustable between the holding position and the releasing position. The driveable part is coupled to an at least one permanent brake. A braking torque of the holding position of the permanent brake acts on the driveable part. The releasing position of the driveable part is freely rotatable with the permanent brake.

The present disclosure relates to a braking device for a driveable part according to the preamble of an independent claim, in particular for use for a vehicle door or a vehicle flap, in particular in an automobile.

### BACKGROUND

In practice, drives are known which displace driveable components, in particular about a pivot axis. An electric motor delivers a sufficiently high torque to overcome the load resulting from the mass of the components. For example, in the case of vehicle flaps such as trunk lids, the drive moves them from a closed position to an open position and back.

The automatic opening, closing, holding and braking of the vehicle flap or vehicle door of an automobile by means of electric drives not only increases convenience, but also offers more safety. On the one hand, for example, tailgates for loading activities can be opened or closed contactlessly by a sensor using a simple foot gesture. On the other hand, electric drives for vehicle doors or vehicle flaps have increased anti-theft protection as a result of their integration into a central locking system of the automobile.

Furthermore, drive-controlled vehicle doors or vehicle flaps can detect an obstacle, for example a hand, that is located between a vehicle door or a vehicle flap and a vehicle door frame via a sensor. As a result, the vehicle door or the vehicle flap is braked via the respective drive so that injuries caused by the hand or another part of the body becoming trapped are avoided. Correspondingly, further drive-controlled components can detect an imminent collision, for example with a wall or with another parked automobile using a sensor, so that damage is avoided during an opening process of the vehicle door or vehicle flap by braking and holding the vehicle door or vehicle flap.

In addition, electric drives must be configured to open and/or close the vehicle door or vehicle flap in the event of the automobile being tilted by a motor delivering a sufficiently high torque. Furthermore, it must be ensured that the electric drives are also able to hold the open vehicle door or the open vehicle flap in an inclined position of the automobile.

When transporting bulky goods that are stored in a trunk, it is also advantageous to lock the tailgate in a defined position so that unwanted automatic opening of the tailgate due to vibrations is prevented. A disadvantage of the known electric drives is that an uninterrupted power supply to the electric drive is required in order to keep the vehicle door or vehicle flap in an intermediate position. This leads to high energy consumption and unnecessary heating of the drives as well as a shortened service life of the components.

Furthermore, the known drives often have slipping clutches so that the part to be driven can be opened or closed manually in the event of a malfunction.

In order to ensure that vehicle doors and vehicle flaps meet the above conditions, electric drives are preferably provided in combination with a braking device in order to open, close, hold a vehicle door or a vehicle flap in a controlled manner or to brake the vehicle door or the vehicle flap in a controlled manner during a movement of the vehicle door or the vehicle flap.

DE 20 2019 100 595 U1 discloses a braking device for a driveable part, in particular for use for a vehicle door or a vehicle flap, in particular in an automobile. The braking device comprises a driveable loading device which can be brought into radial contact with the driveable part with a first holding position and a second releasing position. On the one hand, in the holding position at least one braking member bears frictionally against a radial circumference of the driveable part, so that the driveable part is secured against rotation with a pre-settable force. On the other hand, in the releasing position the braking member is spaced from the radial circumference of the driveable part so that a freewheeling of the driveable part is permitted. The loading device can be adjusted between the holding position and the releasing position by means of a drive. A disadvantage of the known braking device is that braking only takes place via frictional contact of the at least one braking member with the driveable part. Accordingly, a precisely defined braking torque of the braking device on a driveable part can neither be precisely adjusted nor delivered.

### SUMMARY

It is an object of the present disclosure to provide a braking device which is reliable and delivers an exact braking torque.

According to one aspect of the present disclosure, a braking device is created for a driveable part, in particular for use in a vehicle door or a vehicle flap, in particular in an automobile. The braking device comprises a driveable loading device which can be brought into radial contact with the driveable part, with a first holding position and a second releasing position, wherein in the holding position at least one braking member bears frictionally against a radial circumference of the driveable part and secures the driveable part against rotation with a pre-settable force, wherein in the releasing position the braking member is spaced from the radial circumference of the driveable part and permits a freewheeling of the driveable part, wherein the loading device is adjustable between the holding position and the releasing position by means of a drive. The braking device is characterized in that the driveable part is coupled to at least one permanent brake. Advantageously, both a short reaction time of the braking device is provided and a precisely defined braking torque is delivered by a combination of a permanent brake with a switchable brake. The permanent brake offers the advantage that it can be precisely preset with regard to a braking torque to be achieved. The switchable brake has a very short reaction time so that the advantage of this combination is that the above braking device has both a braking torque that can be precisely preset by the permanent brake and a very fast reaction time of the loading device.

Expediently, the braking member of the loading device can be brought into radial contact with a housing portion of the permanent brake. Advantageously, a housing portion of the permanent brake is arranged at the same height as the braking member of the loading device. Consequently, the braking member of the loading device can radially grip an outer surface of the housing portion of the permanent brake so that a braking force acts on the housing portion, thereby locking the housing portion of the permanent brake.

Preferably, in the holding position a braking torque of the permanent brake acts on the driveable part. Advantageously, a precisely defined braking torque is thereby delivered to the driveable part which is preset in advance with regard to the permanent brake. In addition, a braking torque of the permanent brake can be individually preset depending on the vehicle model, ensuring a wide range of possible applications with regard to the weight of a vehicle door or a vehicle flap.

Expediently, in the releasing position the driveable part is freely rotatable with the permanent brake. Advantageously, in the releasing position no braking takes place by the permanent brake of the driveable part so that energy is saved and components are not unnecessarily exposed to wear, thereby increasing their service life. Furthermore, unwanted noises, for example friction noises, are avoided during the operation of a vehicle door or a vehicle flap.

Preferably, the driveable part comprises a shaft or a spindle. The shaft or spindle mainly serves to adjust vehicle doors or vehicle flaps by means of, for example, an electric drive and a corresponding gear configuration. Advantageously, the braking effect of the permanent brake on the driveable part is delivered exclusively in the holding position so that in the releasing position the permanent brake is freely rotatable together with the shaft or spindle of the driveable part on which the permanent brake is arranged or coupled. Advantageously, the braking torque is precisely adjustable with respect to the permanent brake so that a precisely defined and a time-controlled or regulated braking torque is delivered as a result of an activation of the braking device.

Preferably, the braking torque of the permanent brake can be adjusted once. The braking torque of the permanent brake is expediently between 0.2 Nm and 3 Nm, preferably between 0.5 Nm and 2 Nm and particularly preferably 1 Nm. Advantageously, the desired braking torque is precisely preset during production of the permanent brake. Furthermore, presetting the braking torque is advantageously carried out only once so that after the braking torque has been preset, the permanent brake is ready for operation.

Expediently, a braking torque of the loading device is at least twice as high as the braking torque of the permanent brake. Advantageously, the permanent brake can be gripped and held by means of the at least one braking member so that the locked housing portion of the permanent brake does not slip in the holding position.

Preferably, an overrunning of the driveable part in the manner of a slipping clutch is provided when the braking torque of the permanent brake is exceeded in the holding position. In the event that the driveable part, which is coupled to the permanent brake, has a higher torque than the braking torque of the permanent brake, the driveable part slips with respect to the permanent brake. This means that the vehicle door or vehicle flap can advantageously be adjusted manually in the event of a malfunction or defect as a result of an integrated slipping clutch.

Expediently, in the holding position the housing portion of the permanent brake which is retained by the braking member is held in position in a non-rotatable manner upon overrunning of the driveable part. This advantageously ensures that only the preset braking torque of the permanent brake is delivered to the driveable part.

Expediently, the loading device is switchable. A switchable loading device has the advantage that it can only be activated or deactivated if required, wherein the loading device advantageously has a very short reaction time. Furthermore, a switchable loading device can advantageously be computer-controlled and can be coupled to corresponding sensors. If, for example, there is a sudden gust of wind, corresponding sensors can register that the respective vehicle door or vehicle flap is opening or closing too quickly. Consequently, this information is processed by a computer which brakes the affected vehicle door or vehicle flap by means of the braking device.

Preferably, a reaction time of the loading device for an adjustment of the braking member is between 30 and 100 milliseconds, preferably between 40 and 80 milliseconds and particularly preferably 60 milliseconds. A fast reaction time of the loading device advantageously increases the operational reliability of the driveable part.

According to a preferred embodiment, the driveable part is arranged coaxially with respect to the permanent brake. In this way, the driveable part is advantageously connected to the permanent brake in a space-saving manner. Furthermore, by means of the coaxial structure, a reliable braking torque is always transmitted from the permanent brake to the driveable part.

According to a further preferred embodiment, the driveable part is arranged concentrically with respect to the permanent brake. This offers the advantage that components coupled to one another have very good concentricity properties. The corresponding components are thus aligned, straight, centered and not offset with respect to one another. This ensures that the moving components run smoothly, which results in an increased service life and advantageously low-noise operation.

Preferably, the permanent brake is configured as a permanent magnet brake and/or as a permanent spring-loaded brake. Various embodiments exist with regard to a permanent brake. The advantage of a permanent magnet brake is that it can be engaged and adjusted, wherein a permanent spring-loaded brake is biased by a spring that permanently delivers a preset braking torque. The advantage of a permanent spring-loaded brake is, among other things, its uncomplicated design, and that it is fail-safe due to its currentless operation, which contributes to a very high level of operational safety.

Preferably, the permanent brake is configured as a combination of a permanent magnet brake and a permanent spring-loaded brake. Advantageously, a switchable permanent brake can be used, which permanently delivers a preset braking torque by means of the spring in a currentless state. This embodiment of a permanent brake is advantageously fail-safe since it also delivers a braking torque without power. Accordingly, the above combination offers, on the one hand, the advantage of switchability and, on the other hand, a very high level of operational safety.

Overall, it is favorable that in the releasing position a radial distance between the housing portion of the permanent brake and the braking member is between 0.2 and 1.2 millimeters, preferably between 0.4 and 0.8 millimeters and particularly preferably 0.5 millimeters. The advantage of the small distance of 0.5 millimeters results in the fast reaction time of the loading device since only a short distance has to be covered with respect to the braking member in order to contact or correspondingly release the housing portion of the permanent brake.

Expediently, a braking contact surface of the braking member is concave. Since the braking contact surface of the braking member has a concave shape, the braking member can advantageously adapt uniformly to an outer lateral surface of the housing portion of the permanent brake during a transition from the releasing position to the holding position and lock it in place. Accordingly, this results in an optimum braking effect, since the entire braking contact surface of the braking member is utilized. According to a further embodiment, the concave braking contact surface of the braking member has a rough friction surface or a rubberized coating, so that an even greater braking effect is achieved.

According to a preferred further development, the permanent brake has a cylindrical or conical or ellipsoidal or hourglass-shaped external geometry. A rotationally symmetrical external geometry of the permanent brake advantageously offers an even load distribution, which results in smooth running and very good concentricity properties of the rotating permanent brake, since an imbalance is avoided, for example. Furthermore, on the one hand, the permanent brake is contacted by the braking member without tilting and, on the other hand, a high braking effect is achieved.

According to a preferred embodiment, the drive is a direct current motor. Advantageously, so-called DC motors have a very high acceleration, a large speed range and a long service life. Furthermore, DC motors are compact and small and DC motors are also very well suited for precise positioning drives. A DC motor is therefore preferably used for adjusting the braking member of the braking device.

Expediently, the drive comprises a shaft which is rotatable in two directions. Advantageously, the shaft of the drive is rotatable either clockwise or counterclockwise.

According to one embodiment variant, the shaft comprises a threaded portion which is in engagement with a nut, wherein the nut is axially displaceable with respect to the drive between the first holding position and the second releasing position. The shaft of the drive with its integrated threaded portion advantageously drives a nut directly so that this can be displaced along a shaft axis as a result of the switchability of the direction of rotation of the shaft, whereby a holding position or a releasing position of the braking device can be adjusted. Furthermore, no further components configured as coupling parts are required for connecting the shaft to the nut.

According to a further alternative embodiment, the drive is a linear motor or a linear actuator or an electromagnetic actuator. In this case, the linear motor or the linear actuator or the electromagnetic actuator preferably comprises a housing and an actuator, wherein the actuator is axially displaceable with respect to a housing between the first holding position and the second releasing position. The braking device can advantageously be equipped with a linear motor or a linear actuator, which facilitates assembly, since, for example, fewer components are required for the braking device. When an electromagnetic actuator is used as a drive, an armature assumes a certain position depending on the current applied to an integrated electromagnet coil. The armature is linearly movable back and forth and has at least two stop positions. Advantageously, it is possible to use different drives in the above braking device so that the possible uses of the braking device are variable with regard to the installation space as well as the desired braking torque or the general sequence of movements.

According to a preferred embodiment, the driveable loading device comprises a first braking member and a second braking member, each of which in the holding position bear frictionally against a radial circumference of the driveable part and secure the driveable part against rotation with a pre-settable force and in the releasing position are spaced from the radial circumference of the driveable part and permit a freewheeling the driveable part, wherein the first braking member is pivotable in an articulated manner about a first pivot joint with a first pivot axis, wherein the second braking member is pivotable in an articulated manner about a second pivot joint with a second pivot axis, and wherein the driveable part is arranged between the drive of the loading device and the two pivot axes.

Advantageously, both the driveable part and the permanent brake are arranged between the drive and the two pivot axes so that the first braking member and the second braking member can grip a housing portion of the permanent brake in a pincer-like manner with a very high braking force as a result of the optimized lever arm lengths. Advantageously, this arrangement offers a compact design of the braking device and the guarantee of a very high braking effect as well as a very fast reaction time with regard to the two braking members.

According to one aspect of the present disclosure, a braking device is created for a driveable part, in particular for use for a vehicle door or a vehicle flap, in particular in an automobile. The braking device comprises a driveable loading device which can be brought into radial contact with the driveable part with a first holding position and a second releasing position, wherein in the holding position a first braking member and a second braking member bear frictionally against a radial circumference of the driveable part and secure the driveable part against rotation with a pre-settable force, wherein in the releasing position the first and the second braking member are spaced from the radial circumference of the driveable part and permit a freewheeling of the driveable part, wherein the loading device is adjustable between the holding position and the releasing position by means of a drive, wherein the first braking member pivotable in an articulated manner about a first pivot joint with a first pivot axis, wherein the second braking member is pivotable in an articulated manner about a second pivot joint with a second pivot axis. The braking device is characterized in that the driveable part is arranged between the drive of the loading device and the two pivot axes.

Advantageously, the driveable part is arranged between the drive and the two pivot axes, so that the first braking member and the second braking member can grip the driveable part in a pincer-like manner with a very high braking force as a result of the optimized lever arm lengths. Advantageously, this arrangement offers a compact design of the braking device and the guarantee of a very high braking effect as well as a very fast reaction time with regard to the two braking members.

Expediently, the drive comprises a motor with a rotatable shaft. Furthermore, the rotatable shaft has a coupling part which can be brought into engagement with a guide part, wherein the guide part is axially displaceable when the shaft is rotated.

Preferably, the coupling part is configured as a cylindrical threaded portion. Furthermore, the guide part is configured as an internally toothed nut which is axially displaced with respect to the motor when the threaded portion is rotated.

This advantageously creates a positive connection between the coupling part and the guide part, according to which the guide part can be driven by means of the coupling part, allowing a controlled pivoting movement of the two braking members. The pivoting movement results either in a holding position or in a releasing position of the loading device.

Expediently, the first braking member contains a first housing for accommodating the motor. Furthermore, the second braking member preferably contains a second housing for accommodating the guide part. Advantageously, the motor and at least one guide part are already integrated into the two braking members within the corresponding housing, so that a compact braking device is provided.

Preferably, the first braking member has a first end and a second end, wherein the first pivot joint is arranged at the first end of the first braking member, and wherein the first housing is arranged at the second end of the first braking member.

Preferably, the second braking member has a first end and a second end, wherein the second pivot joint is arranged at the first end of the second braking member, and wherein the second housing is arranged at the second end of the second braking member.

Advantageously, both braking members each have a pivot joint and both braking members each have a housing. Accordingly, the first braking member and the second braking member are optimally utilized in terms of installation space, providing a compact braking device. Furthermore, the direct installation of a motor in one of the above braking members results in an increased reaction speed of the braking device, so that the desired braking effect and the safety of the braking device are ensured.

According to a further development, the first housing and the second housing each comprise a removable cover. Advantageously, the interior of the respective housing is protected from moisture, dust and other possible contamination by means of a corresponding cover which, among other things, preferably provides a seal made of a plastics material. Furthermore, a removable cover offers the advantage that, in the event of a malfunction or a defect, the drive and the guide part can be replaced or repaired. The drive and the guide part can therefore be reused. Another advantage of a cover is that noise is reduced, allowing the braking device to operate quietly.

Preferably, the first housing has a first through-opening and the second housing has a second through-opening. The openings of the corresponding housings are advantageously configured for cable feed-throughs as well as for a shaft feed-through or actuator feed-through, for example. The openings are configured so that the shaft or the actuator can move smoothly. Furthermore, the possibility is provided that a cable strain relief and a cable kink protector are mounted on an outer side of the openings with respect to at least one cable feed-through in order to counteract a possible cable break.

Expediently, the shaft is arranged in a direction towards the second housing. Optimum utilization of installation space is advantageously created by the above arrangement of the drive.

Expediently, the guide part is movable back and forth within the second housing. This advantageously enables a pivoting movement of the first braking member and the second braking member by displacing the guide part within the second housing in a controlled manner. Depending on the position of the guide part, the loading device is in the releasing position or in the holding position.

According to a preferred embodiment, a first material portion with a first eye extends from the first braking member in a direction towards the second braking member. According to a further preferred embodiment, a second material portion with a second eye extends from the second braking member in a direction towards the first braking member. In this case, the first eye and the second eye are preferably each configured as an elongated hole. Furthermore, a pin expediently passes through the first eye of the first material portion and/or the second eye of the second material portion.

Overall, it is advantageous that the first material portion and the second material portion are arranged in an overlapping manner, wherein the first material portion is preferably arranged above the second material portion. Advantageously, a scissor-like arrangement of the two material sections makes optimum use of the installation space in order to provide a compact braking device.

Expediently, the pin is an end stop with respect to the first braking member and the second braking member. Advantageously, a flat material portion with a corresponding elongated hole extends from both braking members. Since a pin passes through the two openings configured as elongated holes, the pivotability of the braking members is restricted by the pin acting as an end stop. The advantage is that in the event of a malfunction or defect, the two braking members cannot be pivoted or displaced outside of a designated area. The end stop in the form of a pin blocks any further undesired pivoting of the first and the second braking member both in the holding position and in the releasing position. In this way, the operational safety of the braking device is reliably guaranteed.

According to a preferred embodiment, the first braking member and the second braking member are each made of at least one plastic material by means of an injection molding process. Advantageously, plastic parts can be produced quickly and economically in large quantities by means of an injection molding process. A further advantage is that plastic parts generally have a lower weight than similar components made of metallic materials, for example, due their density properties. Furthermore, the braking members which are produced as plastic parts can comprise several plastics materials by means of, for example, a double injection molding process. Advantageously, a braking member thus comprises at least two different plastics materials. The braking member is thus made of a primary plastics material, wherein, for example, a further rubber-like plastics material with a friction surface is arranged in the concave contact region of the braking member in order to increase the frictional force or the holding force or the braking force between the permanent brake or the driveable part and the braking member.

Overall, it is advantageous that the first braking member and the second braking member are synchronously pivotable. Advantageously, a uniform braking force is thereby transmitted to the driveable part. This leads to a maximum braking effect, to low-noise operation of the braking device, and an increased service life of the components.

Further advantages, properties, characteristics and developments of the present disclosure can be found in the following description of a preferred embodiment and in the dependent claims.

### BRIEF SUMMARY OF THE DRAWINGS

The present disclosure will now be explained in more detail with reference to the accompanying drawings.

FIG. 1 shows a schematic perspective view of the braking device according to the present disclosure from above.

FIG. 2 shows a top view of the braking device from FIG. 1 in the holding position.

FIG. 3 shows a top view of the braking device from FIG. 1 in the releasing position.

### DETAILED DESCRIPTION

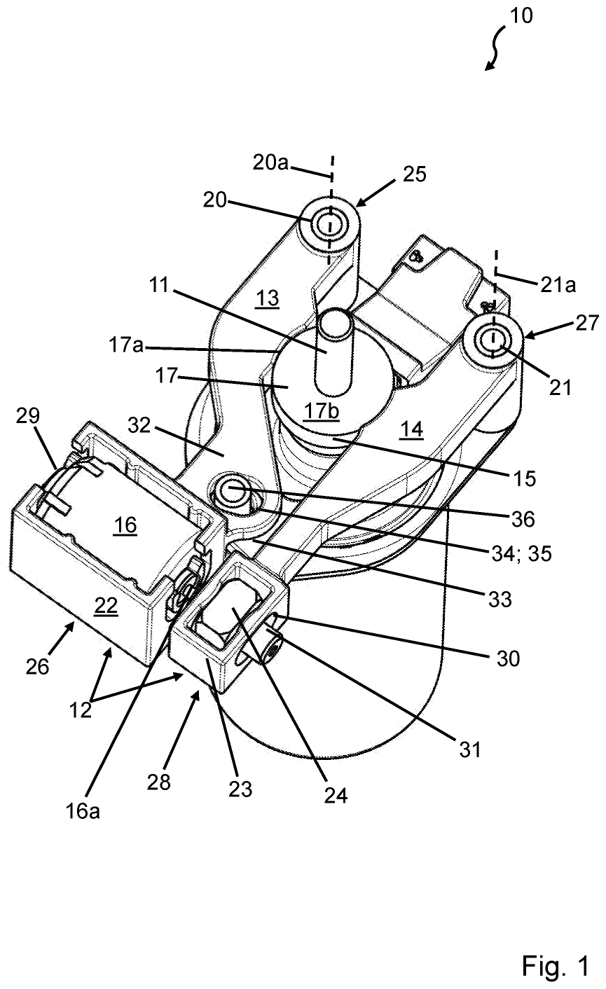

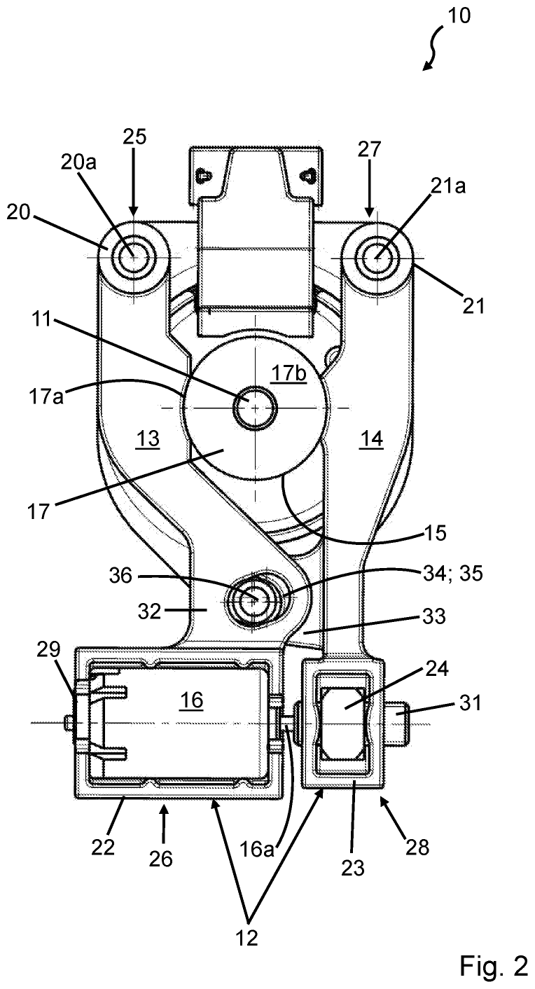

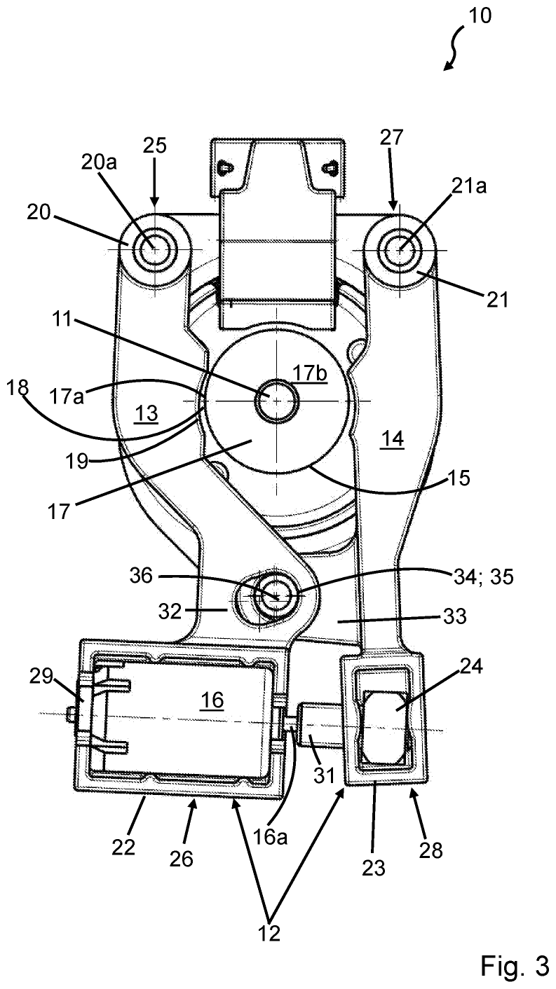

FIG. 1 schematically shows a braking device 10 for a driveable part 11 in a perspective view from above. The braking device 10 comprises an electrically driven, switchable loading device 12 with a first braking member 13 and a second braking member 14 as well as a permanent brake 17 that can be preset with respect to a braking torque. The loading device 12 substantially has two functions, namely a first holding position according to FIG. 1 and FIG. 2 and a second releasing position according to FIG. 3. The driveable part 11, which is not completely shown in FIG. 1 for reasons of clarity, comprises a portion which is coupled to the permanent brake 17, for example by means of a positive shaft-hub connection. Accordingly, in the releasing position the driveable part 11 is freely rotatable together with the permanent brake 17. FIG. 1 shows a housing portion 17a of the permanent brake 17 in the holding position. In the holding position, which is also shown in FIG. 2, the first braking member 13 and the second braking member 14 of the loading device 12 grip around a radial outer surface of the housing portion 17a of the permanent brake 17 in a pincer-like manner. In order to achieve better adhesion and a higher braking effect on the part of the loading device 12, the first braking member 13 and the second braking member 14 have a concave braking contact surface 19, which is shown in FIG. 3, the radius of which corresponds to an outer radius of the housing portion 17a of the permanent brake 17. Furthermore, the two concave braking contact surfaces 19 can each have a plastic coating, for example made of a rubber-like material.

In the holding position, the housing portion 17a of the permanent brake 17 is in a locked state. Consequently, any further rotation of the housing portion 17a of the permanent brake 17 is prevented. A precisely preset braking torque, which is delivered exclusively by the permanent brake 17, now acts on the driveable part 11. Here, however, it is necessary that the braking torque of the loading device 12 corresponds to a value approximately twice as high as the preset braking torque of the permanent brake 17. In this way, the locked housing portion 17a of the permanent brake 17 is prevented from slipping between the first braking member 13 and the second braking member 14 in the holding position. The releasing position shown in FIG. 3 requires the first braking member 13 and the second braking member 14 to be separated from the housing portion 17a of the permanent brake 17 by a radial distance 18 of approximately 0.5 mm. Advantageously, the switching on or switching off of the loading device 12 only takes about 60 milliseconds, so that a very high level of operational reliability is ensured due of the short response time.

The first braking member 13 comprises a first end 25 and an opposite second end 26, wherein the second end 26 of the first braking member 13 is configured as a first housing 22 for accommodating a drive 16, in particular a direct current motor or DC motor. The first end 25 of the first braking member 13 has a region in which a first recess is arranged for connecting a first pivot joint 20.

The second braking member 14 comprises a first end 27 and an opposite second end 28, wherein the second end 28 of the second braking member 14 is configured as a second housing 23 for accommodating at least one guide part 24, for example a screw nut 24. The first end 27 of the second braking member 14 has a region in which a second recess is arranged for a connecting a second pivot joint 21.

In the first housing 22 of the first braking member 13, a direct current motor or DC motor with a rotatable shaft 16a is inserted in a direction towards the second housing 23 of the second braking member 14. The second housing 23 comprises at least one insertable guide part 24 which is movable back and forth within the second housing 23. The guide part 24 is a screw nut 24.

A coupling part 31 which has an external thread is arranged on the shaft 16a of the DC motor. Since the first housing 22 and the second housing 23 have a first frontal through-opening 29 and a second through-opening 30, the coupling part 31 is coupled to the screw nut 24, wherein the coupling part 31 passes through the screw nut 24 and the second opening 30. For this purpose, the coupling part 31 and the screw nut 24 each have a corresponding internal thread or external thread, which creates a screw connection.

In order to now move the loading device 12 into the holding position, the rotating shaft 16a drives the coupling part 31 within the screw nut 24 so that the first housing 22 and the second housing 23 approach one another until the housing portion 17a of the permanent brake 17 is gripped radially in a region of the braking contact surface 19 by means of the first braking member 13 and the second braking member 14.

In order to return to the releasing position according to FIG. 3 of the loading device 12, the rotating shaft 16a drives the coupling part 31 in an opposite direction within the screw nut 24 so that the first housing 22 and the second housing 23 move away from one another until the housing portion 17a of the permanent brake 17 is completely released by means of the first braking member 13 and the second braking member 14.

The second housing 23 functions as a type of abutment for the inserted screw nut 24, wherein the second through-opening 30 is configured in the form of an elongated hole in order to ensure a back-and-forth movement of the guide part 24 together with the coupling part 31 within the second housing 23.

Instead of a motor with a rotatable shaft 16a, a linear motor or a linear actuator with a linearly moving coupling part 31 can be considered, which linear motor can be coupled to an opposite guide part 24. In the event of a linear movement of the coupling part 31, the guide part 24 comprises, for example, a joint-like connecting element.

An end stop of the braking device 10 is arranged adjacent to the first housing 22 of the first braking member 13 and adjacent to the second housing 23 of the second braking member 14. A first flat material portion 32 with a first eye 34 configured as an elongated hole extends from the first braking member 13 in a direction towards the second braking member 14. A second flat material portion 33 with a second eye 35 configured as an elongated hole extends from the second braking member 14 in a direction towards the first braking member 13. The first material portion 32 and the second material portion 33 are arranged so as to overlap, wherein a pin 36 passes through the first eye 34 and the second eye 35. In this case, the pin 36 acts as an end stop which limits the pivoting movement of the first braking member 13 and the second braking member 14 both in a direction towards the holding position and in a direction towards the releasing position.

Furthermore, the first housing 22 of the first braking member 13 and the second housing 23 of the second braking member 14 each comprise a removable cover, which is clipped on, plugged on or screwed on, for example. For the sake of clarity, no cover is shown in the figures presented. The covers of the respective housings 22; 23 also each have a seal which protects the contents of the housings 22; 23 from moisture, dust, dirt, or other undesired components. Furthermore, the first housing 22 comprises a cable strain relief and a cable kink protector in order to increase the service life of the cables of the electric drive.

For reasons of economic efficiency, weight, but also due to the electrical insulation, the first braking member 13 and the second braking member 14 are produced from at least one plastic material by means of an injection molding process. Furthermore, the use of plastic materials for the above braking device 10 provides a reduced noise level during operation.

What is claimed is:

1-43. (canceled)

44: A braking device for a driveable part comprising:
a driveable loading device configured for being brought into radial contact with the driveable part having a first holding position and a second releasing position,
wherein in said holding position at least one braking member bears frictionally against a radial circumference of the driveable part and secures the driveable part against rotation with a pre-settable force,
wherein in said releasing position the braking member is spaced from the radial circumference of the driveable part and permits a freewheeling of the driveable part,
wherein the loading device is adjustable between the holding position and the releasing position by means of a drive,
wherein the driveable part is coupled to at least one permanent brake,
wherein the braking member of the loading device is configured for being brought into radial contact with a housing portion of the permanent brake,
wherein in the holding position a braking torque of the permanent brake acts on the driveable part, and
wherein in the releasing position the driveable part is freely rotatable with the permanent brake.

45: The braking device according to claim 44, wherein the driveable part comprises a shaft or a spindle.

46: The braking device according to claim 44, wherein the braking torque of the permanent brake is between 0.2 Nm and 3 Nm.

47: The braking device according to claim 44, wherein a braking torque of the loading device is at least twice as high as the braking torque of the permanent brake.

48: The braking device according to claim 44, wherein the loading device is switchable.

49: The braking device according to claim 44, wherein the driveable part is arranged concentrically and coaxially with respect to the permanent brake.

50: The braking device according to claim 44, wherein the permanent brake is at least one unit selected from the group comprising a permanent magnet brake and a permanent spring-loaded brake.

51: The braking device according to claim 44, wherein an overrunning of the driveable part in the manner of a slipping clutch is provided when the braking torque of the permanent brake is exceeded in the holding position.

52: The braking device according to claim 44, wherein in the holding position the housing portion of the permanent brake which is retained by the braking member is held in position in a non-rotatable manner upon overrunning of the driveable part.

53: The braking device according to claim 44, wherein in the releasing position a radial distance between the housing portion of the permanent brake and the braking member is between 0.2 and 1.2 millimeters.

54: The braking device according to claim 44, wherein a braking contact surface of the braking member is concave.

55: The braking device according to claim 44, wherein the permanent brake having at least one external geometry selected from the group comprising a cylindrical, a conical, an ellipsoidal and an hourglass-shaped external geometry.

56: The braking device according to claim 44, wherein the drive is a direct current motor, and wherein the drive comprises a shaft which is rotatable in two directions.

57: The braking device according to claim 56, wherein said shaft comprises a threaded portion which is in engagement with a nut, wherein the nut is axially displaceable with respect to the drive between the first holding position and the second releasing position.

58: The braking device according to claim 44, wherein the drive is at least one unit selected from the group comprising a linear motor, a linear actuator and an electromagnetic actuator.

59: The braking device according to claim 44,
wherein the driveable loading device comprises a first braking member and a second braking member each of which in the holding position bear frictionally against a radial circumference of the driveable part and secure the driveable part against rotation with a pre-settable force and in the releasing position are spaced from the radial circumference of the driveable part and permit a freewheeling of the driveable part,
wherein the first braking member is pivotable in an articulated manner about a first pivot joint with a first pivot axis,
wherein the second braking member is pivotable in an articulated manner about a second pivot joint with a second pivot axis, and
wherein the driveable part is arranged between the drive of the loading device and the first and second pivot axes.

60: A braking device for a driveable part comprising:
a driveable loading device configured for being brought into radial contact with the driveable part having a first holding position and a second releasing position,
wherein in said holding position a first braking member and a second braking member bear frictionally against a radial circumference of the driveable part and secure the driveable part against rotation with a pre-settable force,
wherein in said releasing position the first and the second braking member are spaced from the radial circumference of the driveable part and permit a freewheeling of the driveable part,
wherein the loading device is adjustable between the holding position and the releasing position by means of a drive,
wherein the first braking member is pivotable in an articulated manner about a first pivot joint with a first pivot axis,
wherein the second braking member is pivotable in an articulated manner about a second pivot joint with a second pivot axis, and
wherein the driveable part is arranged between the drive of the loading device and the first and second pivot axes.

61: The braking device according to claim 60,
wherein the drive comprises a motor with a rotatable shaft, wherein said rotatable shaft comprises a coupling part, and
wherein a guide part configured for being brought into engagement with the coupling part is axially displaceable when the shaft is rotated.

62: The braking device according to claim 61,
wherein the coupling part is configured as a cylindrical threaded portion, and
wherein the guide part is configured as an internally toothed nut which is axially displaced with respect to the motor when the threaded portion is rotated.

63: The braking device according to claim 60,
wherein a first material portion having a first eye extends from the first braking member in a direction towards the second braking member, and
wherein a second material portion having a second eye extends from the second braking member in a direction towards the first braking member,
wherein said first eye and said second eye are each configured as an elongated hole,
wherein a pin passes through the first eye of the first material portion and/or the second eye of the second material portion, and
wherein said pin is an end stop with respect to the first braking member and the second braking member.
